(19) United States
(12) Patent Application Publication
(10) Pub. No.: US 2026/0254373 A1
(43) Pub. Date: Aug. 27, 2026

(54) BI-DIRECTIONAL POWER CONVERSION DEVICE AND AUXILIARY POWER GENERATION CIRCUIT THEREOF

(71) Applicant: Lite-On Technology Corporation, Taipei (TW)

(72) Inventors: Yi Chao Fan, Taipei (TW); Pei-Syuan Chang, Taipei (TW)

(73) Assignee: Lite-On Technology Corporation, Taipei (TW)

(21) Appl. No.: 19/246,715

(22) Filed: Jun. 24, 2025

Related U.S. Application Data
(60) Provisional application No. 63/756,280, filed on Feb. 10, 2025.

(30) Foreign Application Priority Data
May 21, 2025 (TW) 114119123

(51) Int. Cl. H02M 7/797; H02J 3/32; H02M 1/00

(52) U.S. Cl. CPC H02M 7/797; H02J 3/32; H02M 1/008

(57) ABSTRACT

A bi-directional power conversion device and an auxiliary power generation circuit thereof are provided. The auxiliary power generation circuit includes a first power transmitter, a second power transmitter and a power converter. The first power transmitter receives a first input power and generates a first voltage. The second power transmitter is coupled with the first power transmitter, and receives a second input power and generates a second voltage. The power converter is coupled with the first power transmitter and the second power transmitter, and generate an auxiliary power according to the first voltage or the second voltage.

### CROSS-REFERENCE TO RELATED APPLICATION

This application claims the priority benefit of U.S. provisional application serial no. 63/756,280, filed on February 10, 2025, and Taiwan application serial no. 114119123, filed on May 21, 2025. The entirety of each of the above-mentioned patent applications is hereby incorporated by reference herein and made a part of this specification.

### BACKGROUND

### Technical Field

The present disclosure relates to a power converter having auxiliary power, and particularly relates to a bidirectional power conversion device and an auxiliary power generation circuit thereof.

### Related Art

In the existing technology of power converters, an AC grid-connected bidirectional power conversion device has an alternating-current (AC) side and a direct-current (DC) side, and both the AC side and the DC side may be a power side or may also be a load side. Therefore, in design, it is required to set different auxiliary power for both sides respectively to comply with the operation mode of the converter and regulatory requirements. Such design requires relatively more circuit area and increases the cost of the product.

### SUMMARY

The present disclosure provides an auxiliary power generation circuit that may effectively reduce the circuit cost of the system.

The auxiliary power generation circuit of the present disclosure includes a first power transmitter, a second power transmitter, and a power converter. The first power transmitter receives a first input power and generates a first voltage. The second power transmitter is coupled with the first power transmitter, receives a second input power, and generates a second voltage. The power converter is coupled with the first power transmitter and the second power transmitter, and generates auxiliary power according to the first voltage or the second voltage.

The bidirectional power conversion device of the present disclosure includes a first power converter, a second power converter, and an auxiliary power generation circuit. The first power converter receives a first power. The second power converter receives a second power. The second power converter is coupled to the first power converter through a power bus. The auxiliary power generation circuit is coupled with the first power converter, the second power converter, and the power bus. The auxiliary power generation circuit includes a first power transmitter, a second power transmitter, and a third power converter. The first power transmitter receives the first power and generates a first voltage. The second power transmitter is coupled with the first power transmitter, and receives the second power and generates a second voltage. The third power converter is coupled with the first power transmitter and the second power transmitter, and generates auxiliary power according to the first voltage or the second voltage.

Based on the above, the auxiliary power generation circuit of the present disclosure is designed to receive an AC power and a DC power, and selects one of the two voltages generated based on the two powers to generate auxiliary power. Therefore, taking this auxiliary power generation circuit as the auxiliary power of the bidirectional power conversion device can reduce manufacturing cost and product volume.

### BRIEF DESCRIPTION OF THE DRAWINGS

FIG. 1 illustrates a schematic diagram of an auxiliary power generation circuit according to an embodiment of the present disclosure.

FIG. 2 illustrates a schematic diagram of an auxiliary power generation circuit according to an embodiment of the present disclosure.

FIG. 3 illustrates a schematic diagram of a bidirectional power conversion device according to an embodiment of the present disclosure.

### DESCRIPTION OF THE EMBODIMENTS

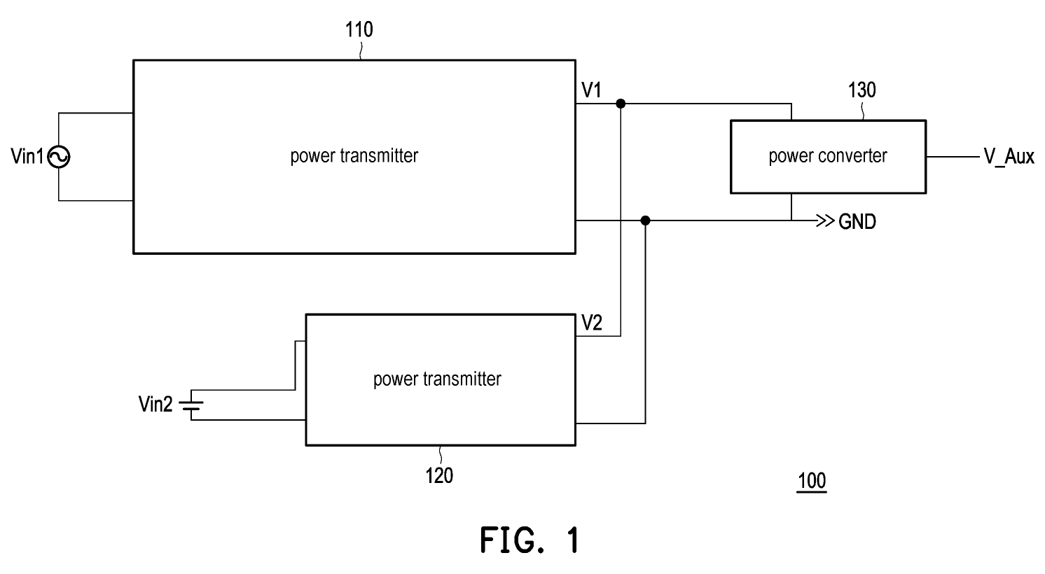

Please refer to FIG. 1, which illustrates a schematic diagram of an auxiliary power generation circuit according to an embodiment of the present disclosure. As shown in FIG. 1, the auxiliary power generation circuit 100 includes a power transmitter 110, a power transmitter 120, and a power converter 130. The power transmitter 110 receives an input power Vin1 and generates a voltage V1 according to the input power Vin1. The power transmitter 120 receives an input power Vin2 and generates a voltage V2 according to the input power Vin2. In this embodiment, the input power Vin1 may be an AC power, and the input power Vin2 may be a DC power.

An output terminal of the power transmitter 110 and an output terminal of the power transmitter 120 are mutually coupled to the power converter 130. Under this circuit configuration, the power converter 130 receives the voltage V1 or the voltage V2, and generates an auxiliary power V_Aux according to the voltage V1 or the voltage V2. Specifically, when a voltage value of the voltage V1 is greater than a voltage value of the voltage V2, the power converter 130 receives the voltage V1 and generates auxiliary power V_Aux according to the voltage V1; conversely, when the voltage value of the voltage V1 is not greater than the voltage value of the voltage V2, the power converter 130 receives the voltage V2 and generates auxiliary power V_Aux according to the voltage V2.

The power transmitter 110, the power transmitter 120, and the power converter 130 are commonly coupled to a same reference ground GND.

In this embodiment, the power converter 130 is a direct-current to direct-current (DC to DC) converter. The power converter 130 may be any form of DC to DC converter, such as a boost converter, a buck converter, or any other form of DC to DC converter well known to those of ordinary skill in the art.

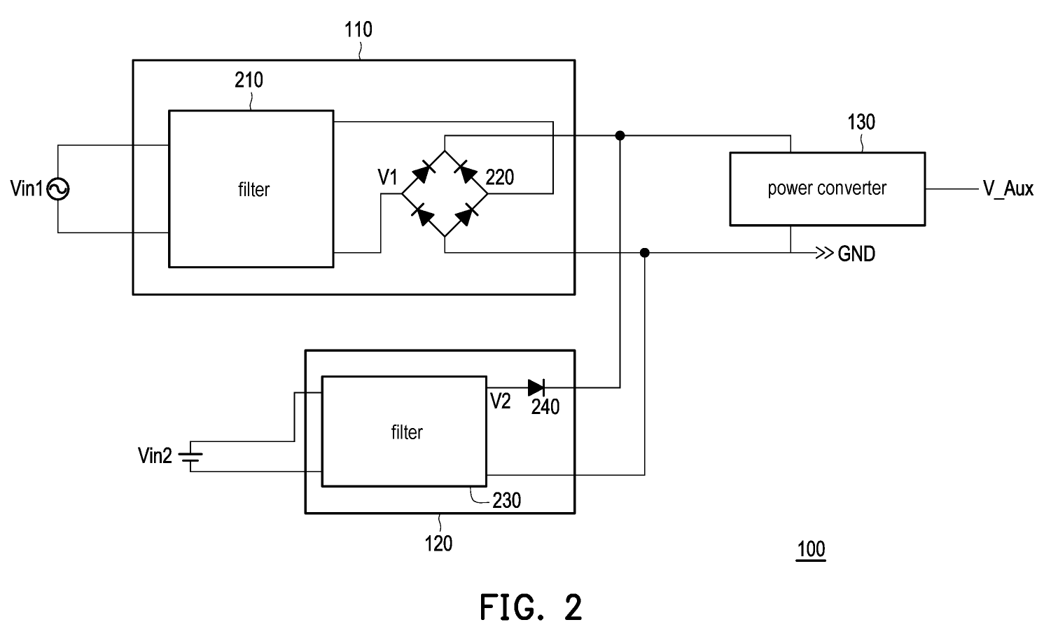

Please refer to FIG. 2, which illustrates a schematic diagram of an implementation of the auxiliary power generation circuit according to an embodiment of the present disclosure. Specifically, the power transmitter 110 includes a filter 210 and a rectifier 220. The power transmitter 110 receives the input power Vin1 through the filter 210. The filter 210 is configured to perform filtering operation on the input power Vin1, thereby filtering out noise on the input power Vin1 and thereby generating the voltage V1. In this embodiment, the filter 210 may be constructed through any form of filtering circuit, such as an electromagnetic interference (EMI) filter.

The rectifier 220 is coupled to the output terminal of the filter 210. The rectifier 220 is configured to receive the voltage V1 generated by the filter 210 and is configured to perform rectifying operation on the voltage V1. In this embodiment, the rectifier 220 may be, for example, a bridge rectifier.

In another aspect, the power transmitter 120 includes a filter 230 and a rectifier 240. The filter 230 receives the input power Vin2 and is configured to filte the input power Vin2 to generate the voltage V2. The filter 230 is coupled to the rectifier 240 and provides the voltage V2 to the rectifier 240. In this embodiment, the filter 230 may be any filter well known to those of ordinary skill in the art, without specific limitation. The rectifier 240 may be a half-wave rectifier, for example, a diode.

Furthermore, the output terminals of the power transmitter 110 and 120 are coupled to each other, thereby causing the output terminals of the rectifier 220 and the rectifier 240 to be coupled to each other. In this way, when the voltage value of the voltage V1 is greater than the voltage value of the voltage V2, the rectifier 220 can be turned on, and correspondingly the rectifier 240 can be cut off. In this way, the rectifier 220 can transmit the voltage V1 to the power converter 130. Furthermore, when the voltage value of the voltage V1 is not greater than the voltage value of the voltage V2, the rectifier 220 can be cut off and the rectifier 240 can be turned on, and the rectifier 240 can transmit the voltage V2 to the power converter 130.

In this way, the power converter 130 may generate the auxiliary power V_AUX according to the voltage V1 or V2, based on voltage states of the input power Vin1 and Vin2.

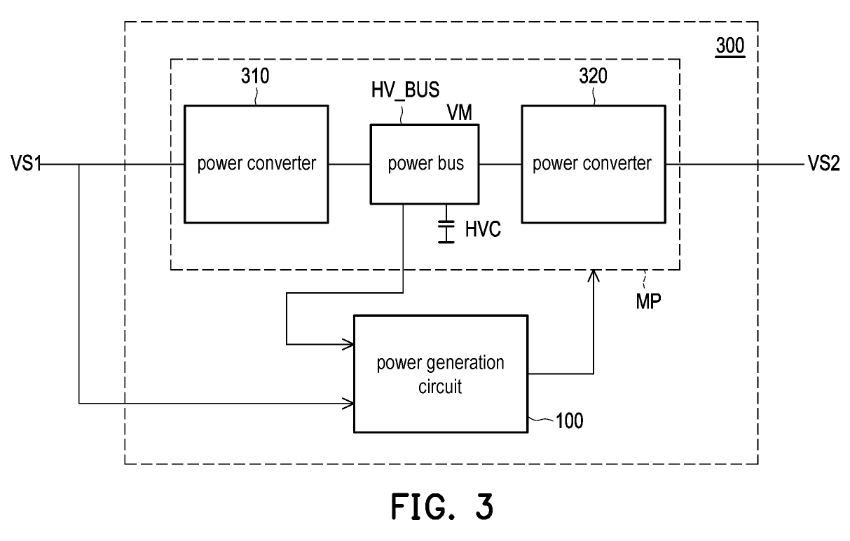

Please refer to FIG. 1 and FIG. 3 together, FIG. 3 illustrates a schematic diagram of a bidirectional power conversion device according to an embodiment of the present disclosure. The bidirectional power conversion device 300 includes a main power generation circuit MP and the auxiliary power generation circuit 100 according to the above various embodiments. In this embodiment, the main power generation circuit MP may have, for example, a power of A1, and the auxiliary power generation circuit 100 may have a power of A2, where A1 is greater than A2. Furthermore, the main power generation circuit MP includes a power converter 310 and a power converter 320. The power converter 310 receives the power VS1. The power converter 320 receives the power VS2. The power converter 320 is coupled to the power converter 310 through a power bus HV_BUS.

In this embodiment, the power converter 310 may be an alternating current to direct current (AC to DC) converter, and the power converter 320 may be a DC to DC converter. The power VS1 may be an AC power such as utility power. The power VS2 may be a DC power provided by any form of energy storage battery. Furthermore, when the power converter 310 is configured to receive the power VS1, the power converter 310 may execute AC to DC power conversion operation on the power VS1 to generate and transmit a power VM which is DC power to the power bus HV_BUS. In this embodiment, the power converter 310 may be a power factor correction (PFC) AC to DC power converter. The power converter 320 may receive the power VM through the power bus HV_BUS and execute DC to DC power conversion operation on the power VM to generate the power VS2 as output power.

In this implement, the power converter 320 may provide the power VS2 as an output power to supply subsequent load components and/or to charge the energy storage battery.

In another implement of the present disclosure, when the power converter 320 is configured to receive the power VS2 as input power, the power converter 320 may execute DC to DC power conversion operation on the power VS2 and thereby generate the power VM which is DC voltage. The power converter 310 may receive the power VM through the power bus HV_BUS and execute DC to AC power conversion operation on the power VM to generate the power VS1 as output power. In this embodiment, the power VS2 as input power received by the power converter 320 may be supplied by the coupled energy storage battery.

The auxiliary power generation circuit 100 is coupled to the power converter 310, the power converter 320, and the power bus HV_BUS. Moreover, the auxiliary power generation circuit 100 may receive the power VS1 as input power Vin1 and receive the power VM as input power Vin2. The auxiliary power generation circuit 100 may generate auxiliary power V_Aux based on the input power Vin1 and the input power Vin2, and transmit the auxiliary power V_Aux to the main power generation circuit MP as the auxiliary power required by the main power generation circuit MP.

Regarding details on the implementation of the auxiliary power generation circuit 100, detailed descriptions have been provided in the aforementioned embodiments of FIG. 1 and FIG. 2, and repetitious description is omitted here.

Please continue to refer to FIG. 3. The bidirectional power conversion device 300 may further include a high voltage capacitor HVC. In some embodiments, the high voltage capacitor HVC is included in the power bus HV_BUS. In other embodiments, the high voltage capacitor HVC may be coupled to the power bus HV_BUS. In this embodiment, the magnitude of the capacitance value of the high voltage capacitor may have an order of magnitude of microfarads or millifarads. When the power VS1 as input AC power is unstable (or when a power outage occurs), the power VS1 may experience a brief drop phenomenon of, for example, about several milliseconds to 1 second. At this time, the high voltage capacitor HVC may enable the power VM to maintain providing sufficient voltage value. Correspondingly, the auxiliary power generation circuit 100 may generate auxiliary voltage V_AUX according to the input power Vin2 having a relatively large voltage value, and thereby enable the bidirectional power conversion device 300 to maintain normal operation. In this way, the bidirectional power conversion device 300 may comply with the AC power low voltage ride-through test required by regulations.

In summary, the bidirectional power conversion device and auxiliary power generation circuit thereof of the present disclosure, in which the bidirectional power conversion device only needs to be provided with a single auxiliary power generation circuit, can effectively reduce the required circuit area and manufacturing cost, and enhance product competitiveness.

What is claimed is:

1. An auxiliary power generation circuit, comprising:
a first power transmitter, receiving a first input power, and generating a first voltage;
a second power transmitter, coupled with the first power transmitter, receiving a second input power and generating a second voltage; and
a power converter, coupled with the first power transmitter and the second power transmitter, and generating an auxiliary power according to the first voltage or the second voltage.

2. The auxiliary power generation circuit according to claim 1, wherein when a voltage value of the first voltage is greater than a voltage value of the second voltage, the power converter generates the auxiliary power according to the first voltage.

3. The auxiliary power generation circuit according to claim 1, wherein when a voltage value of the first voltage is less than a voltage value of the second voltage, the power converter generates the auxiliary power according to the second voltage.

4. The auxiliary power generation circuit according to claim 1, wherein the first power transmitter comprises:
a first filter; and
a first rectifier, coupled between the first filter and the power converter,
wherein the first filter provides the first voltage to the first rectifier.

5. The auxiliary power generation circuit according to claim 4, wherein the second power transmitter comprises:
a second filter; and
a second rectifier, coupled between the second filter and the power converter,
wherein the second filter provides the second voltage to the second rectifier.

6. The auxiliary power generation circuit according to claim 5, wherein output terminals of the first rectifier and the second rectifier are coupled to each other, when the first voltage is greater than the second voltage, the first rectifier is turned on and the second rectifier is cut off; and when the first voltage is not greater than the second voltage, the first rectifier is cut off and the second rectifier is turned on.

7. The auxiliary power generation circuit according to claim 5, wherein the first rectifier is a bridge rectifier, and the second rectifier is a diode.

8. The auxiliary power generation circuit according to claim 1, wherein the first input power is alternating-current (AC) power, and the second input power is direct-current (DC) power.

9. A bidirectional power conversion device, comprising:
a first power converter, receiving a first power;
a second power converter, receiving a second power, and the second power converter is coupled to the first power converter through a power bus; and
an auxiliary power generation circuit, coupled to the first power converter, the second power converter and the power bus, wherein the auxiliary power generation circuit comprises:
a first power transmitter, receiving the first power and generating a first voltage;
a second power transmitter, coupled with the first power transmitter, and receiving the second power and generating a second voltage; and
a third power converter, coupled with the first power transmitter and the second power transmitter and generating an auxiliary power according to the first voltage or the second voltage.

10. The bidirectional power conversion device according to claim 9, wherein when a voltage value of the first voltage is greater than a voltage value of the second voltage, the third power converter generates the auxiliary power according to the first voltage.

11. The bidirectional power conversion device according to claim 9, wherein when a voltage value of the first voltage is less than a voltage value of the second voltage, the third power converter generates the auxiliary power according to the second voltage.

12. The bidirectional power conversion device according to claim 9, wherein the first power transmitter comprises:
a first filter; and
a first rectifier, coupled between the first filter and the third power converter,
wherein the first filter provides the first voltage to the first rectifier.

13. The bidirectional power conversion device according to claim 12, wherein the second power transmitter comprises:
a second filter; and
a second rectifier, coupled between the second filter and the power converter,
wherein the second filter provides the second voltage to the second rectifier.

14. The bidirectional power conversion device according to claim 13, wherein output terminals of the first rectifier and the second rectifier are coupled to each other, when the first voltage is greater than the second voltage, the first rectifier is turned on and the second rectifier is cut off; and when the first voltage is not greater than the second voltage, the first rectifier is cut off and the second rectifier is turned on.

15. The bidirectional power conversion device according to claim 13, wherein the first rectifier is a bridge rectifier, and the second rectifier is a diode.

16. The bidirectional power conversion device according to claim 9, wherein a first input power and the first power are alternating-current (AC) power, and the second power and a second input power are direct-current (DC) power.

17. The bidirectional power conversion device according to claim 9, wherein the first power converter is an AC to DC power converter, and the second power converter is a DC to AC power converter.

18. The bidirectional power conversion device according to claim 9, further comprising:
a high voltage capacitor, coupled to the power bus.
